(19) United States
(12) Patent Application Publication
(10) Pub. No.: US 2015/0077429 A1
(43) Pub. Date: Mar. 19, 2015

(54) DISPLAY CONTROL DEVICE AND DISPLAY DEVICE

(71) Applicant: Sharp Kabushiki Kaisha, Osaka (JP)

(72) Inventors: Makoto Eguchi, Osaka (JP); Shinya Yamasaki, Osaka (JP); Misa Kubota, Osaka (JP)

(73) Assignee: SHARP KABUSHIKI KAISHA, Osaka (JP)

(21) Appl. No.: 14/391,315

(22) PCT Filed: Apr. 5, 2013
(86) PCT No.: PCT/JP2013/060548

§ 371 Date: Oct. 8, 2014

(30) Foreign Application Priority Data
Apr. 11, 2012 (JP) 2012-090072

(51) Int. Cl. G09G 5/10; G09G 5/02

(52) U.S. Cl. CPC G09G 5/10; G09G 5/02; G09G 2354/00; G09G 2360/144; G09G 2320/0626; G09G 2320/0666
USPC 345/589

(57) ABSTRACT

An object of the present invention is, in a display device to be seen by a plurality of users, to improve visual properties for a user who carries out a task such as an input, without sacrificing visual properties in the screen as a whole. A display control device illuminates a backlight to reach a first luminosity of a predetermined first display condition in a display region of a display panel. When a contact location is detected, the display control device identifies a control region for which the contact location in the display region is a reference. Then, the display control device switches from illuminating the backlight at the first display condition to illuminating the backlight at a second luminance of a second display condition in which the perceived brightness is lower than that of the first display condition, whereas the backlight is illuminated at the first luminance of the first display condition in areas other than the control region.

### TECHNICAL FIELD

The present invention relates to a display control device and a display device, and in particular, refers to a technique of controlling display performed by a display device seen by a plurality of users.

### BACKGROUND ART

In recent years, various display control techniques regarding display devices having large display screens such as electronic blackboards have been developed. Japanese Patent Application Laid-Open Publication No. 2009-166293 discloses a technique of displaying drawing data that follows the will of the person inputting data to an electronic blackboard. Also, Japanese Patent Application Laid-Open Publication No. 2011-247983 discloses a technique in which sound and display brightness are changed depending on the relative positional relationship between the display device and the user.

### SUMMARY OF THE INVENTION

However, large display devices such as electronic blackboards have a brightness that takes into account the fact that a plurality of users view such display devices at a certain distance therefrom. Thus, those who input data to the display device and are therefore close thereto perceive the display device as being excessively bright, and working under such an environment for a long period of time exacerbates fatigue in the user.

The present invention provides a technique in which, in a display device to be viewed by a plurality of users, visual characteristics are improved for users performing input and the like without compromising the visual characteristics of the display as a whole.

A display control device of the present invention includes: a designating unit that, when positional information indicating a contact position on a display area of a display panel is inputted, designates as a control region an area of a predetermined range in the display area based on the contact position indicated by the positional information; and a control unit that performs display control such that in the control region designated by the designating unit, display control is switched from a first display condition preset in the entire display area including the control region to a second display condition in which perceived brightness is reduced compared to the first display condition, and in areas of the display area other than the control region, display control is performed according to the first display condition.

The display control device of the present invention can improve visual characteristics for users performing input and the like without compromising the visual characteristics of the display as a whole.

### BRIEF DESCRIPTION OF THE DRAWINGS

FIG. 1 is a block diagram showing a configuration example of a display device according to Embodiment 1.

FIG. 2 is a block diagram showing various parts connected to the display panel of Embodiment 1.

FIG. 3 shows an example of a voltage conversion curve in Embodiment 1.

FIG. 4 is a schematic view of a backlight in Embodiment 1.

FIG. 5A describes the visual range of a user performing input.

FIG. 5B shows an example of a control region of Embodiment 1.

FIG. 5C shows an example of a control region.

FIG. 6 shows an operation flow chart showing an operational example of a display device according to Embodiment 1.

FIG. 7 shows an operation flow chart showing an operational example of a display device according to Embodiment 2.

FIG. 8 is a block diagram showing various parts connected to a display panel of Embodiment 3.

FIG. 9 shows an example of a voltage conversion curve in Embodiment 3.

FIG. 10 shows an operation flow chart showing an operational example of a display device according to Embodiment 3.

FIG. 11A is block diagram of a configuration example of a display device according to Embodiment 4.

FIG. 11B shows an example of where a filter is disposed in Embodiment 4.

FIG. 12 shows an operation flow chart showing an operational example of a display device according to Embodiment 4.

FIG. 13 shows a relation between the brightness of a display device and the brightness of the surrounding environment in Modification Example 1.

### DETAILED DESCRIPTION OF EMBODIMENTS

A display control device of one embodiment of the present invention includes: a designating unit that, when positional information indicating a contact position on a display area of a display panel is inputted, designates as a control region an area of a predetermined range in the display area based on the contact position indicated by the positional information; and a control unit that performs display control such that in the control region designated by the designating unit, display control is switched from a first display condition preset in the entire display area including the control region to a second display condition in which perceived brightness is reduced compared to the first display condition, and in areas of the display area other than the control region, display control is performed according to the first display condition (first configuration). Perceived brightness is the brightness of light radiated from the display panel as perceived by a user touching a display area. In general, when performing input or the like in the display area of the display panel, the user looks at the location of input. Therefore, a position in the display area being touched corresponds to the position that the user is viewing. In this configuration, in the display area, a range predetermined on the basis of where the user has touched is a control region, and the brightness of the control region is adjusted by having the control region perform display according to the second display condition, while performing display in other areas according to the first display condition. As a result, visual characteristics can be improved for users performing input and the like without compromising the visual characteristics of the display area as a whole.

In the first configuration, the second configuration may be configured such that the first display condition is a condition in which light is radiated from an illumination unit from a rear of the display panel such that the light is at a first luminance preset for the entire display area, and the second display condition is a condition in which light is radiated from the illumination unit at a second luminance less than the first luminance in the control region, and at the first luminance in areas other than the control region. In this configuration, the light radiated from the control region is less intense than in other areas, and thus, when performing input, the display brightness is reduced.

In the first configuration, the third configuration may be configured such that the first display condition is a condition in which an image is displayed in the display area on the basis of a first gradation value preset for inputted image data, and the second display condition is a condition in which an image is displayed in the control region by switching from the first gradation value of the image data inputted to the control region to a second gradation value less than the first gradation value, and an image is displayed in the areas other than the control region on the basis of the first gradation value of image data inputted to the areas other than the control region. In this configuration, an image having a lower than normal gradation is displayed in the control region. Thus, the control region is shown as darker than in other areas, and therefore, the brightness of the image when performing input is reduced.

In the first configuration, the fourth configuration may be configured such that wherein the first display condition is a condition in which an image is displayed in the display area on the basis of a first voltage value preset for inputted image data, and wherein the second display condition is a condition in which an image is displayed in the control region by switching from the first voltage value of the image data inputted to the control region to a second voltage value less than the first voltage value, and an image is displayed in the areas other than the control region on the basis of the first voltage value of image data inputted to the areas other than the control region. In this configuration, the image in the control region is shown at a lower than normal brightness, and thus, visual characteristics for the user performing input are improved.

In the first configuration, the fifth configuration may be configured such that the first display condition is a condition in which, in a filter provided to correspond in position with the display panel, a second filter image of a preset color is displayed in a filter region corresponding to the display area, and the second display condition is a condition in which, in portions of the filter region corresponding to the control region, a first filter image having a lower brightness than the second filter image is displayed, and in portions of the filter region corresponding to the areas other than the control region, the second filter image is displayed. In this configuration, a filter image having a lower brightness than in other areas is displayed over an image to be displayed in the control region. As a result, the control region performs display at a lower brightness than other regions, and thus, visual characteristics are improved for a user performing input or the like.

In the first configuration, the sixth configuration may be configured such that the first display condition is a condition in which an image is displayed in the display area on the basis of a first current value preset for inputted image data, and the second display condition is a condition in which an image is displayed in the control region by switching from the first current value of the image data inputted to the control region to a second current value less than the first current value, and an image is displayed in the areas other than the control region on the basis of the first current value of image data inputted to the areas other than the control region. In this configuration, the image in the control region is shown at a lower than normal brightness, and thus, visual characteristics for the user performing input are improved.

In any of the first to sixth configurations, the seventh configuration may further include a light detection unit that detects surrounding light, wherein the control unit adjusts at least the second display condition on the basis of results of detection performed by the light detection unit. In this configuration, it is possible to control the brightness of the control region based on the brightness of the surrounding environment.

In any of the first to seventh configurations, the eighth configuration may further include a face detection unit that detects a direction that a face of a user performing input faces, wherein the control unit performs display control according to the second display condition in the control region if the face of the user detected by the face detection unit faces the display area. In this configuration, it is possible to control the brightness of the control region based on the direction that the face of the user performing input faces.

In any of the first to eighth configurations, the ninth configuration may be configured such that the control unit switches from performing display control of the control region according to the second display condition to performing display control according to the first display condition if a predetermined period of time has elapsed from when display control according to the second display condition has started. In this configuration, the brightness of the control region controlled according to the second display condition is preset and maintained over a period of time.

A display device of one embodiment of the present invention may include: the display control device of any of the first to ninth configurations; a display panel that displays an image according to a command from the display control device; and a touch panel that outputs positional information indicating a position touched by a user to the display control device (ninth configuration). In this configuration, the visual characteristics can be improved for the user performing input or the like without compromising the visual characteristics of the image as a whole.

Specific embodiments of the present invention will be explained below with reference to figures. In the drawings referred to below, for ease of description, among the components of the embodiments of the present invention, only main members necessary for describing the present invention will be shown, in a simplified manner. Therefore, the display device of the present invention can include appropriate components not shown in the various drawings referred to in the present specification. Portions in the drawings that are the same or similar are assigned the same reference characters and descriptions thereof will not be repeated.

### Embodiment 1

### Configuration

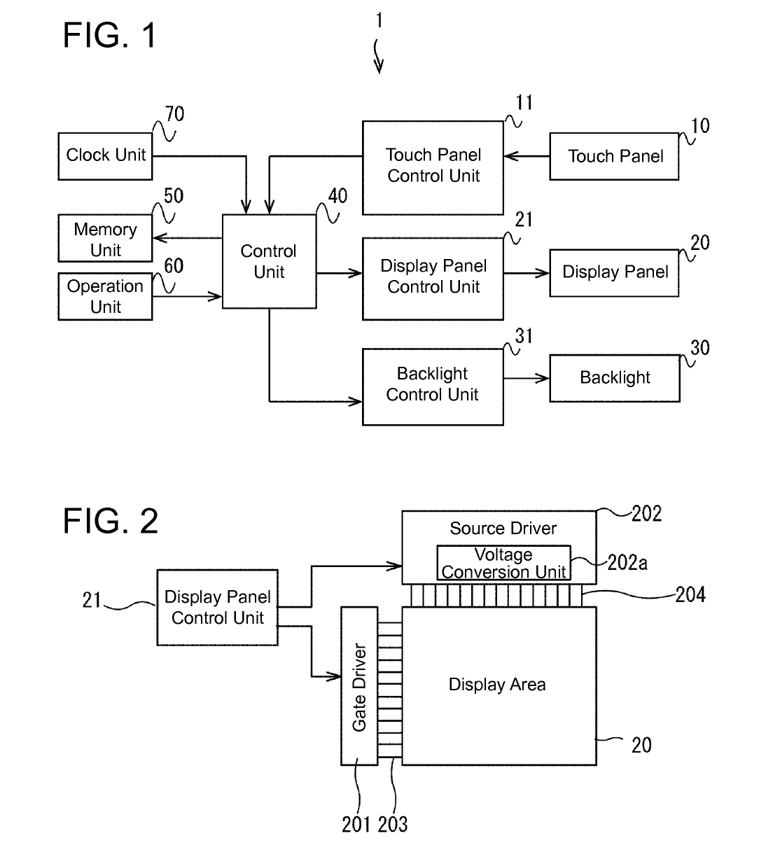

FIG. 1 is a block diagram showing a configuration example of a display device of Embodiment 1 of the present invention. As shown in FIG. 1, the display device 1 has a touch panel 10, a touch panel control unit 11, a display panel 20, a display panel control unit 21, a backlight 30, a backlight control unit 31, a control unit 40, a memory unit 50, an operation unit 60, and a clock unit 70. The display device 1 is an electronic blackboard, for example, and displays images in the display panel 20 and performs processes based on operations on the touch panel 10 made by the user. Details of the respective components will be explained below.

The touch panel 10 functions as an input unit for receiving commands that a user makes through contact from a finger. In the present embodiment, the touch panel 10 is a resistive touch panel, for example. The touch panel 10 is disposed such that the input area for receiving user commands coincides with the display area of a display panel 20 to be mentioned later.

The touch panel control unit 11 has a CPU (central processing unit), and a memory including ROM (read only memory) and RAM (random access memory). The touch panel control unit 11 detects a voltage based on a position in the input area of the touch panel 10, or in other words, the display area where the finger of a user has come into contact, and determines the position that the finger of the user came into contact (absolute coordinates) based on the detection result. The touch panel control unit 11 outputs the positional information indicating the detected position to the control unit 40. In the present embodiment, an example is described in which input is performed on the touch panel 10 by the user's finger, but a configuration may be adopted in which an operation element such as a stylus is used to perform input on the touch panel 10.

The display panel 20 is a transmissive liquid crystal panel in the present embodiment. The display panel 20 includes an active matrix substrate, an opposite substrate, and a liquid crystal layer (none of which are shown). Pixel electrodes are formed to be connected to drain electrodes on the active matrix substrate. A common electrode is formed on the opposite substrate. The liquid crystal layer is sealed between the active matrix substrate and the opposite substrate. The display panel 20 has a plurality of pixels arranged in a matrix (not shown). The area where the plurality of pixels are formed is the display area. In the present embodiment, the pixels include a plurality of sub-pixels including R (red), G (green), and B (blue) as colors.

FIG. 2 is a block diagram showing the respective units connected to the display panel 20. The display panel control unit 21 has a CPU and a memory (ROM and RAM). A gate driver 201 transmits scan signals to a plurality of gate lines 203 connected to the gate electrodes of the thin film transistors formed on the active matrix substrate of the display panel 20. When scan signals are inputted from the gate lines 203 to the gate electrodes, the thin film transistors are driven in response to the scan signal.

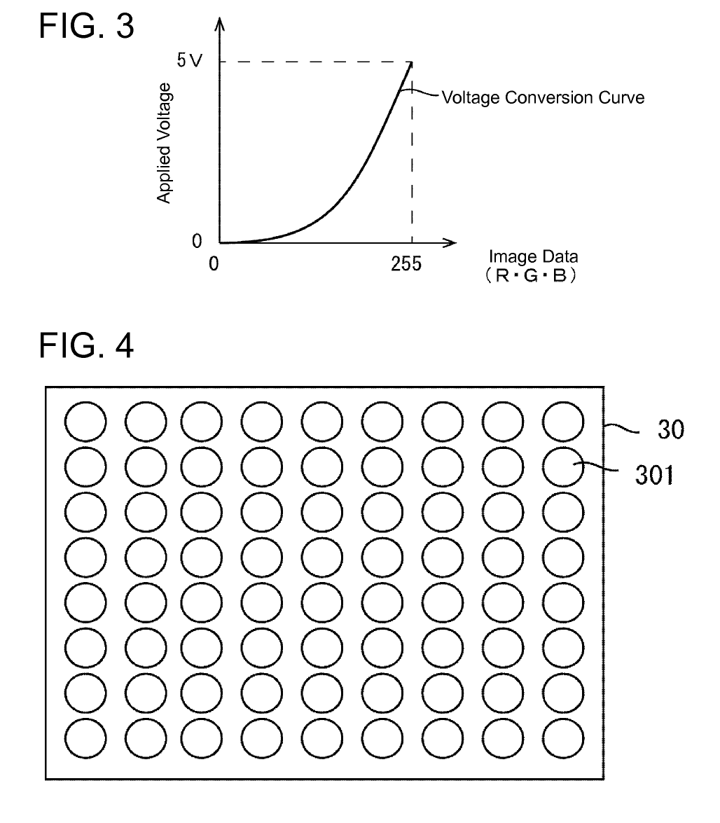

A source driver 202 has a voltage conversion unit 202a. The voltage conversion unit 202a is a digital/analog conversion circuit that converts pixel data to voltage signals based on gamma characteristics of the liquid crystal layer. Specifically, the voltage conversion unit 202a converts the RGB pixel data to a voltage signal based on a voltage conversion curve for each color RGB as shown in FIG. 3 as an example. The source driver 202 sends to a plurality of source lines a voltage signal in synchronization with the output timing of the scan signal sent by the gate driver 201, the plurality of source lines being connected to the source electrodes of the thin film transistors formed on the active matrix substrate of the display panel 20. As a result, liquid crystal molecules in the liquid crystal layer between the pixel electrodes and the common electrode change orientation in response to the voltage signals, and the gradation of each pixel is thereby controlled. As a result, an image based on the image signals is displayed in the display panel 20.

Further descriptions will be made of FIG. 1. The backlight 30 is an example of an illumination unit. The backlight 30 is disposed on the rear side of the display panel 20 (opposite to the user), and radiates light towards the display panel 20. FIG. 4 schematically shows the backlight 30 of the present embodiment. The backlight 30 is of a direct-lit type, and has a plurality of light sources 301 that are LEDs (light emitting diodes). The backlight 30 illuminates the respective light sources 301 on the basis of control signals from the backlight control unit 31.

The backlight control unit 31 has a CPU and a memory (ROM and RAM). In the ROM, absolute coordinates in the display area corresponding to the positions of the light sources 301 and identification information of the light sources 301 are stored as information on where the light sources 301 are disposed. The backlight control unit 31 controls the brightness of the backlight 30 on the basis of signals from the control unit 40. In the present embodiment, an example is described in which the brightness is controlled by outputting to the backlight 30 a control signal indicating the voltage based on luminance, but a configuration may be adopted in which the brightness is controlled by outputting to the backlight 30 a control signal in which the pulse width of a PWM (pulse width modulation) signal is adjusted based on the luminance, or these two techniques may be used together to control the brightness.

Specifically, the backlight control unit 31 receives signals from the control unit 40 indicating where the brightness of the backlight 30 is to be controlled. These signals include a signal indicating the entire display area and a signal of a portion of the display area where the brightness of the screen is to be different (hereinafter referred to as a control region). When the backlight control unit 31 receives the signal indicating the entire display area, it outputs a control signal based on a preset luminance (hereinafter referred to as a first luminance) to all of the light sources 301. When the backlight control unit 31 receives a signal indicating a control region, it identifies the coordinate range of light sources 301 included in the coordinates of the control region, referring to information on where the light sources 301 are disposed. It then outputs a control signal based on a luminance smaller than the first luminance (hereinafter referred to as a second luminance) to the light sources 301 within the identified coordinate range, and outputs a control signal based on the first luminance to the light sources 301 in the rest of the display area. In other words, the second luminance is appropriately set to reduce the perceived brightness of light emitted from the screen when the backlight 30 is illuminated at the first luminance. Also, when the backlight control unit 31 receives from the control unit 40 a signal indicating termination of the control region, then it outputs a control signal based on the first luminance to the light sources 301 presently in the control region to switch from the second luminance.

The control unit 40 has a CPU and a memory (ROM and RAM). The control unit 40 controls the respective units connected thereto by the CPU thereof executing control programs stored in the ROM. Specifically, the control unit 40 receives command signals from the operation unit 60 and positional information from the touch panel control unit 11 to generate image data or read in image data from the memory unit 50, and then outputs an image signal indicating image data to the display panel control unit 21. The control unit 40 determines coordinates of the control region based on coordinates indicated by the positional information from the touch panel control unit 11, and outputs a signal indicating the specified control region to the backlight control unit 31.

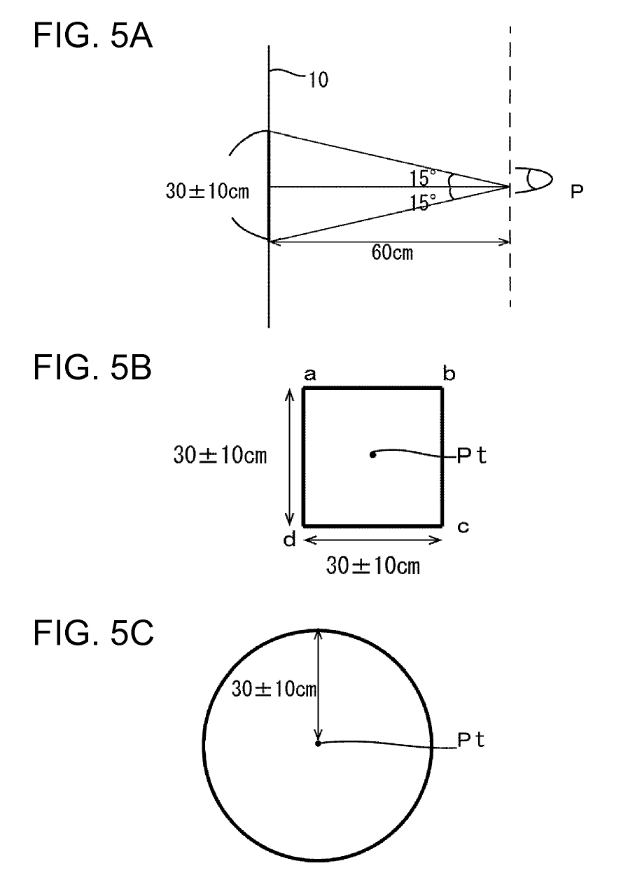

The control region will be described here. The control region indicates the visual range of the user when the user performs input on the touch panel 10. FIG. 5A shows the visual range of the user when the user performs input on the touch panel 10. Specifically, if the visual distance from a position P of the user to the touch panel 10 is approximately 60 cm and the central field of vision of humans is approximately 30°, then as shown in FIG. 5A, the visual range of the user is 30±10 cm with the position that the user is looking at being the center.

If the display device is an electronic blackboard or the like to be viewed by a plurality of users, then the luminance of the screen is set to be even based on the idea that the users will view the screen at a distance from the display device. As a result, the user who is performing input to the touch panel 30 described above perceives the light emitted from the screen as excessively bright, making work over long periods difficult. In the present embodiment, the brightness of the control region corresponding to the visual range of the user performing input is made darker than other areas. That is, in the control region, the backlight 30 is switched from the first luminance preset for the display area to a second luminance that is less than the first luminance.

In the present embodiment, the position of contact where the finger of the user is in contact with the touch panel 10 is set as the position that the user is viewing, and as shown in FIG. 5B, the control region is set as a rectangular area with each side being 30±10 cm, with a contact position Pt being the center. The control unit 40 specifies the coordinates of the corners (a, b, c, d) of the rectangle as absolute coordinates of the control region. Specifically, the control unit 40 determines the coordinates of the respective corners of the control region using a formula to determine the coordinates of the corners as parameters of the absolute coordinates of the contact position Pt. The shape of the control region is not limited to being a rectangle with the contact position Pt being the center, and instead may be a polygon such as a pentagon or a hexagon, or it may be a circle with a radius of 30±10 cm with the contact position Pt as the center as shown in FIG. 5C.

In the present embodiment, the first luminance is an example of a first display condition, and the second luminance is an example of a second display condition. The control unit 40 and the backlight control unit 31 are examples of a determining unit and a control unit.

Further descriptions will be made of FIG. 1. The memory unit 50 is a storage medium such as a hard disk, and stores various data such as application programs to be operated in the display device 1 and image data. The operation unit 60 is an operation element such as a power switch or a menu button of the display device 1. The operation unit 60 outputs an operation signal indicating operations by the user and outputs this to the control unit 40. The clock unit 70 performs clocking based on a clock signal from a clock feed unit that is not shown.

(Operation)

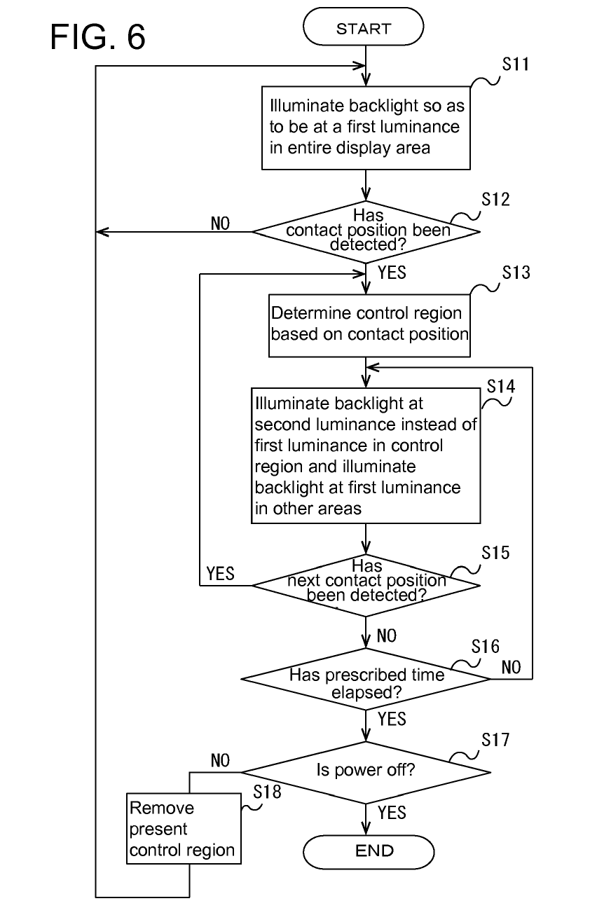

FIG. 6 is a diagram showing an operational flow of the display device 1. Operations of the display device 1 will be described below with reference to FIG. 6. In this operational example, the power switch of the display device 1 is switched ON.

The control unit 40 outputs a signal representing the entire display area to the backlight control unit 31. The backlight control unit 31 outputs a control signal corresponding to the first luminance to the backlight 30 based on a signal from the control unit 40 (step S11). As a result, the respective light sources 301 of the backlight 30 to which the control signal is inputted are illuminated at a brightness based on the first luminance.

When the user touches the touch panel 10, the touch panel control unit 11 detects the coordinates of the contact position Pt where the finger of the user has come into contact, and transmits the positional information including the detected coordinate data to the control unit 40 (step S12: YES). The control unit 40 obtains positional information outputted from the touch panel control unit 11 and causes the clock unit 70 to begin clocking. The control unit 40 uses a predetermined formula to determine the coordinates of the control region based on the coordinates of the obtained positional information (step S13).

The control unit 40 transmits a signal indicating the coordinates of the control region determined in step S13 to the backlight control unit 31. The backlight control unit 31 reads in information of where the light sources 301 are disposed from the ROM, and based on the signal outputted from the control unit 40 determines the range of coordinates of the light sources 301 included in the coordinates of the control region. The backlight control unit 31 then stores the identification information of the light sources 301 in the determined coordinate range in the RAM. The backlight control unit 31 outputs to these light sources 301 a control signal corresponding to the second luminance, switching from the first luminance (step S14). As a result, the respective light sources 301 of the backlight 30 in areas other than the control region continue to be illuminated at the first luminance, and the light sources 301 of the backlight 30 in the control region are illuminated at the second luminance. As a result, the control region is displayed to be darker than the rest of the display area.

The control unit 40 performs a process similar to step S14 mentioned above if position information indicating the next contact position is not transmitted by the touch panel control unit 11 (step S15=NO), and if a predetermined time clocked by the clock unit 70 has not elapsed (step S16=NO). In other words, this is a case in which the finger of the user has not come into contact with any location on the touch panel 10 after a certain period of time has elapsed since the finger of the user came into contact with a position on the touch panel 10. Therefore, in this case, until a certain period of time has passed, the control region based on the current contact position is displayed to be darker than the rest of the display area.

If a predetermined amount of time clocked by the clock unit 70 has passed (step S16=YES), and if there is no operation to turn OFF the power through the operation unit 60 (step S17=NO), then the control unit 40 outputs a signal turning off the current control region to the backlight control unit 31 (step S18), and then performs the above-mentioned steps from step S11. As a result, all light sources 301 in the backlight 30 are illuminated at a brightness based on the first luminance. On the other hand, if the power source is turned OFF and the operation signal to do so is received through the operation unit 60 (step S17=YES), then the control unit 40 ends the display control process.

In the step S12, if the position information indicating the contact position is not transmitted by the touch panel control unit 11 (step S12=NO), then the control unit 40 continues a state in which the backlight control unit 31 causes all light sources 301 in the backlight 30 to be illuminated at the brightness according to the first luminance (step S11). Also, in the step S15, if position information indicating the next contact position is transmitted by the touch panel control unit 11 (step S15=YES), then the control unit 40 performs steps from step S13.

In Embodiment 1 above, in the control region, which is based on the contact position where the finger of the user has come into contact with the touch panel 10, the light from the backlight 30 is adjusted such that the luminance thereof is lower than the preset luminance. As a result, the control region becomes darker than other areas, and in the position of the user performing input on the touch panel 10, the brightness of the light emitted by the screen is decreased, thereby improving the visual characteristics for the user performing input. Also, from positions farther away from the display device 1, even if the control region is made difficult to see by the user performing input on the touch panel 10 and the control region becomes darker than other regions, the luminance of the screen as a whole does not greatly decrease, and thus, the visual characteristics for users farther away from the display device 1 are not compromised.

### Embodiment 2

In Embodiment 1, an example was described in which the perceived brightness of the control region was adjusted by controlling the illumination of the backlight 30. In the present embodiment, an example will be described in which the perceived brightness of the control region is adjusted by controlling the gradation of the image displayed in the control region. Below, portions differing from Embodiment 1 will be described.

If a finger of a user comes into contact with a touch panel 10, the control unit 40 switches from outputting to the display panel control unit 21 a first image signal indicating the respective gradation values of RGB (hereinafter referred to as first image data) preset in image data to be displayed in the control region based on the contact position and indicating coordinates of the region where the image is to be displayed, to outputting a second image signal indicating gradation values smaller than the first image data (hereinafter referred to as second image data) and coordinates of the control region. The second image data includes values calculated by multiplying the respective gradation values of the first image data by 0.5, for example, the second image data is not limited thereto as long as the gradation values of the second image data are less than the first image data.

In the present embodiment, the gradation values of the first image data are one example of first gradation values and the gradation values of the second image data are one example of second gradation values. The control unit 40 and the display panel control unit 21 are examples of a determining unit and a control unit.

(Operation)

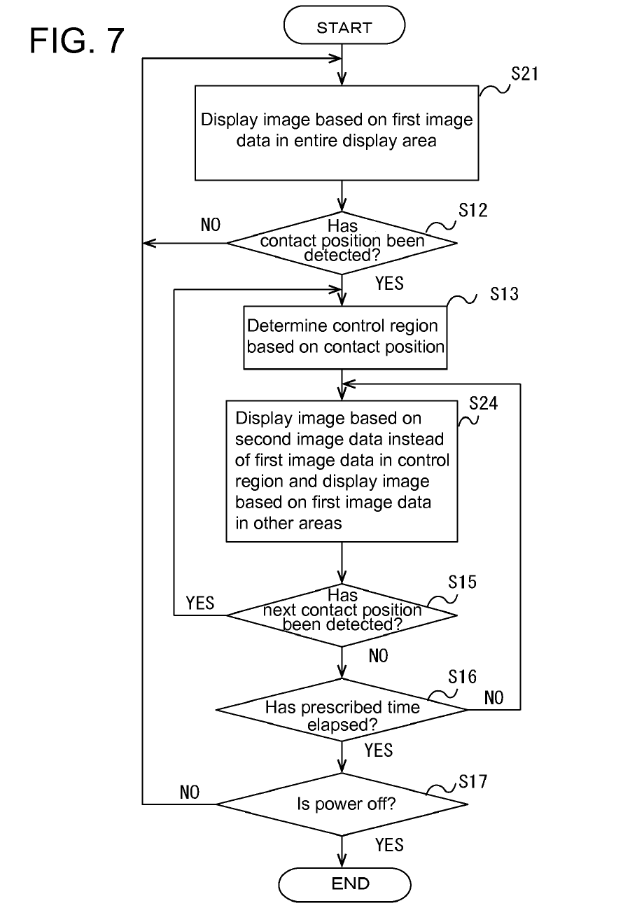

FIG. 7 is a plan view that shows an operational flow of a display device 1 of the present embodiment. An operation example of the display device 1 will be described below with reference to FIG. 7. In this operation example, the power switch of the display device 1 is turned ON in advance, and the operation to display image data in a memory unit 50 through an operation unit 60 is performed by the user.

The control unit 40 reads in image data from the memory unit 50, and outputs a first image signal indicating the read image data (first image data) to the display panel control unit 21. The display panel control unit 21 outputs to the display panel 20 a scan signal from the gate driver 201 through the gate lines 203. Also, the source driver 202 converts the first image data to a voltage signal and outputs the voltage signal to the display panel 20 through the source lines 204 (step S21). As a result, an image having gradations predetermined in the first image data is displayed in the display panel 20.

When the user touches the touch panel 10, the touch panel control unit 11 transmits position information indicating the contact position on the touch panel 10 to the control unit 40 (step S12=YES). The control unit 40 obtains the position information from the touch panel control unit 11, starts clocking by the clock unit 70, and determines the coordinates of the control region based on the position information (step S13).

The control unit 40 outputs to the display panel control unit 21 a first image signal indicating the coordinates of the region where the image is to be displayed and the first image data as image data to be displayed in areas other than the control region. As for image data to be displayed in the control region, a second image signal indicating the coordinates of the control region and second image data obtained by multiplying the RGB values of the image data by 0.5 is outputted to the display panel control unit 21 (step S24).

The control unit 40 continually performs a process similar to step S24 mentioned above if position information indicating the next contact position is not transmitted by the touch panel control unit 11 (step S15=NO), and if a predetermined time clocked by the clock unit 70 has not elapsed (step S16=NO). As a result, in the control region, an image having gradations lower than the predetermined gradations is displayed, and thus, the control region is displayed to be darker than other areas.

Also, the control unit 40 continues a process similar to step S21 described above if a predetermined time clocked by the clock unit 70 has elapsed (step S16=YES), and if an operation to turn OFF the power has not been performed through the operation unit 60 (step S17=NO). As a result, the difference in gradation between the control region and other areas becomes small, and the display area has a uniform brightness. The control unit 40 removes the current control region and ends the display control process if an operation to turn OFF the power is performed through the operation unit 60 (step S17=YES).

In Embodiment 2 above, if the finger of the user comes into contact with the touch panel 10, then the second image data having gradation values smaller than those preset in the image data to be displayed in the control region is outputted to the display panel control unit 21. As a result, the difference in gradation between the control region and other areas becomes larger, and an image darker than in other areas is displayed in the control region. As a result, the brightness of the image for the user performing input on the touch panel 10 is reduced, thereby improving the visual characteristics for the user performing input.

### Embodiment 3

In Embodiment 2 described above, an example was described in which the perceived brightness of the control region is adjusted by changing the gradation values of the image data displayed in the control region. In the present embodiment, an example will be described in which the perceived brightness of the control region is adjusted by changing the voltage applied to the display panel 20 based on the image data displayed in the control region. Portions differing from Embodiments 1 and 2 above will be described below.

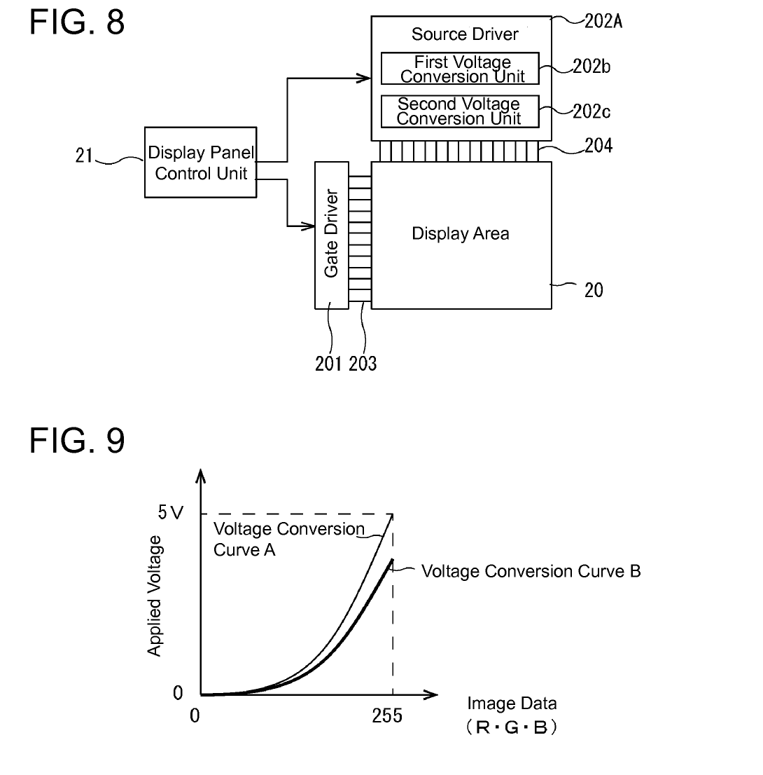

FIG. 8 is a drawing showing respective portions connected to the display panel 20 of the present embodiment. A source driver 202a has a first voltage conversion unit 202b and a second voltage conversion unit 202c. The first voltage conversion unit 202b and the second voltage conversion unit 202c respectively include analog/digital conversion circuits.

The first voltage conversion unit 202b converts the image data to a voltage signal based on a voltage conversion curve A shown as an example in FIG. 9 for each color RGB. The voltage conversion curve A is a voltage conversion curve that, like Embodiment 1, is predetermined based on the gamma characteristics of the liquid crystal layer. Also, the second voltage conversion unit 202c converts the image data to a voltage signal based on a voltage conversion curve B shown as an example in FIG. 9 for each color RGB. As shown in FIG. 9, the voltage conversion curve B has smaller voltage values for the same image data values compared to the voltage conversion curve A. In other words, if voltage conversion is performed by the second voltage conversion unit 202c, then compared to a case in which voltage conversion is performed by the first voltage conversion unit 202b, the image displayed in the display panel 20 is darker.

If the finger of the user comes into contact with the touch panel 10, then the control unit 40 outputs a signal indicating image data to be displayed in the control region and the control region (the coordinates of the control region and the control region), among image data to be displayed in the display panel 20. On the other hand, as for image data to be displayed in areas other than the control region, a signal indicating this image data and the display area is outputted to the display panel control unit 21.

The display panel control unit 21 causes the second voltage conversion unit 202c of the source driver 202A to convert the image data to voltage signals and to output the voltage signals to the respective source lines 204 when image data in the control region is received from the control unit 40. Also, if image data in areas of the display area other than the control region is received from the control unit 40, the image data is converted by the first voltage conversion unit 202b of the source driver 202A into voltage signals, which are then outputted to the respective source lines 204.

In the present embodiment, the voltage values converted by the first voltage conversion unit 202b are an example of first voltage values, and the voltage values converted by the second voltage conversion unit 202c are an example of second voltage values. The control unit 40 and the display panel control unit 40 are examples of a determining unit and a control unit.

(Operation)

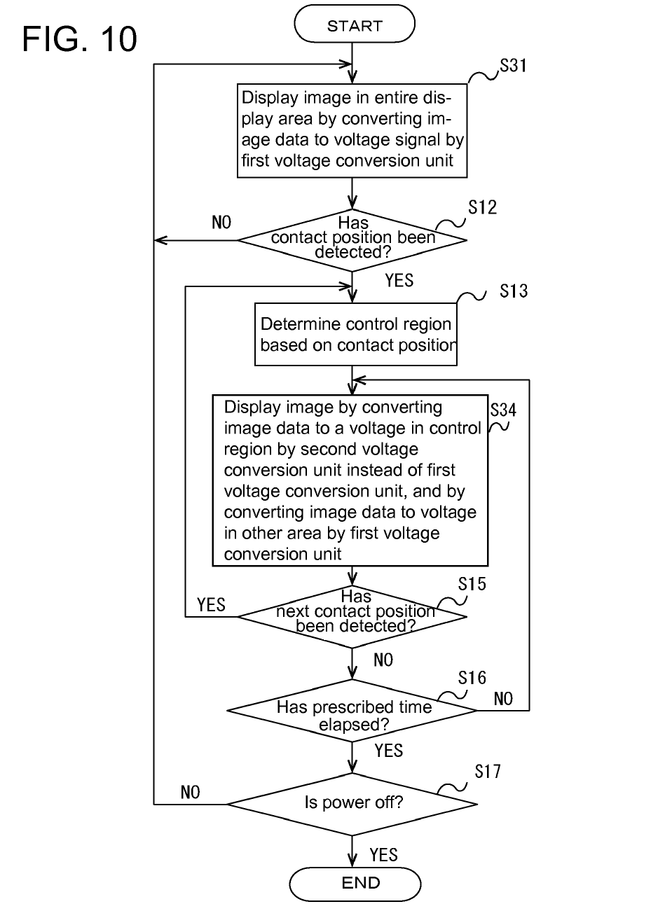

FIG. 10 is a plan view that shows an operational flow of a display device 1 of the present embodiment. An operation example of the display device 1 will be described below with reference to FIG. 10. In this operation example, the power switch of the display device 1 is turned ON in advance, and the operation to display image data in a memory unit 50 through an operation unit 60 is performed by the user.

The control unit 40 reads in image data from the memory unit 50 and outputs the image data to the display panel control unit 21. The display panel control unit 21 outputs to the display panel 20 a scan signal from the gate driver 201 through the gate lines 203. Also, the image data is converted to voltage signals in the first voltage conversion unit 202b of the source driver 202A, and the voltage signals are outputted to the display panel 20 through the respective source lines 204 (step S31). As a result, an image of a color predetermined in the image data is displayed in the display panel 20.

When the user touches the touch panel 10, the touch panel control unit 11 transmits position information indicating the contact position on the touch panel 10 to the control unit 40 (step S12=YES). The control unit 40 obtains the position information from the touch panel control unit 11, starts clocking by the clock unit 70, and determines the coordinates of the control region based on the position information (step S13).

The control unit 40 outputs to the display panel control unit 21 signals indicating the image data to be displayed in the control region and the control region. Also, as for image data to be displayed in areas other than the control region, the control unit 40 outputs a signal indicating this image data and the display area to the display panel control unit 21. The display panel control unit 21 causes the second voltage conversion unit 202c of the source driver 202A to convert the image data to voltage signals when image data in the control region is received from the control unit 40. Also, when image data in areas other than the control region is received from the control unit 40, the image data is converted to voltage signals by the first voltage conversion unit 202b in the source driver 202A. The source driver 202A then outputs the voltage signals to the display panel 20 through the respective source lines 204 (step S34). As a result, an image darker than the predetermined brightness of the image data to be displayed is displayed in the control region.

The control unit 40 continually performs a process similar to step S34 mentioned above if position information indicating the next contact position is not transmitted by the touch panel control unit 11 (step S15=NO), and if a predetermined time clocked by the clock unit 70 has not elapsed (step S16=NO).

Also, the control unit 40 performs the above-mentioned step S31 if the predetermined time clocked by the clock unit 70 has elapsed (step S16=YES), and if the power of the display device 1 is not OFF (step S17=NO). As a result, in the entire display area, an image is displayed at a brightness predetermined by the image data to be displayed. The control unit 40 removes the current control region and ends the display control process if it receives an operation signal to turn OFF the power of the display device 1 from the operation unit 60.

In Embodiment 3 above, when the finger of the user comes into contact with the touch panel 10, the image data to be displayed in the control region is converted to a voltage signal of an image darker than the brightness set in the image data. Thus, compared to Embodiment 2 in which the perceived brightness of the control region is adjusted by reducing the gradation values of the image data, it is possible to improve the visual characteristics for the user performing input without causing gradation collapse.

### Embodiment 4

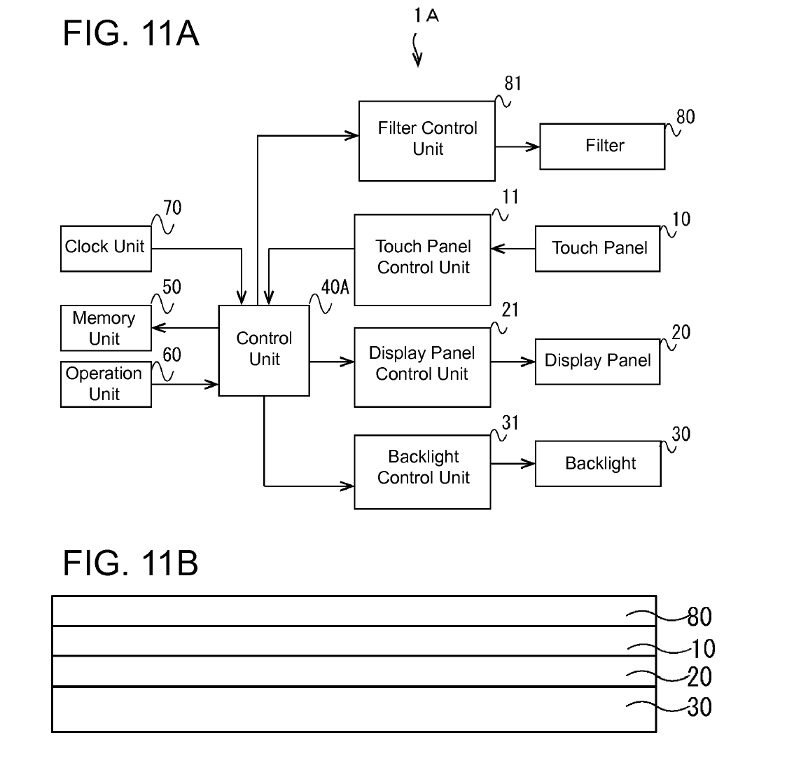

FIG. 11A is a block diagram showing a configuration example of a display device 1A according to the present embodiment. In FIG. 11A, configurations that are the same as those of Embodiment 1 are assigned the same reference characters thereof. As shown in FIG. 11A, the display device 1A has a filter 80 and a filter control unit 81. In the present embodiment, as shown in FIG. 11B, the filter 80 is provided on the upper surface of the touch panel 10 or in other words, towards the user performing input. The position where the filter 80 is provided is not limited thereto, and the filter 80 may be provided between the touch panel 10 and the display panel 20 or between the display panel 20 and the backlight 30.

The filter 80 is a liquid crystal panel or the like similar to the display panel 20, for example. The filter control unit 81 has a CPU and a memory (ROM and RAM). The filter control unit 81 causes an image to be displayed in a portion corresponding to the display area of the filter 80 based on signals from the control unit 40A. Specifically, the portion of the filter 80 corresponding to the control region displays a halftone image, for example (hereinafter referred to as a first filter image), and other portions display a white image (hereinafter referred to as a second filter image). By displaying such an image in the filter 80, a halftone image is overlaid over an image displayed in the control region of the display panel 20. In the present embodiment, an example is described in which a halftone image is displayed as the first filter image and a white image is displayed as the second filter image, but the first filter image and the second filter image simply need to be of a brightness such that the image displayed in the display area can be seen by the user, and the first filter image and the second filter image need to be as dark as possible.

The control unit 40A outputs to the filter control unit 81 signals indicating the coordinates of the portion of the filter 80 corresponding to the control region based on the contact position (hereinafter referred to as a first filter region), and indicating first filter image data to be displayed in the first filter region, if the surface of the filter 80 is pressed by the finger of the user and the pressed portion contacts the touch panel 10. The control unit 40A outputs to the filter control unit 81 coordinates of portions of the filter 80 corresponding to areas other than the control region (hereinafter referred to as a second filter region), and second filter image data to be displayed in the second filter region.

In the present embodiment, the display of the second filter image by the filter 80 is one example of the first display condition, and the display of the first filter image by the filter 80 is one example of the second display condition. The control unit 40A and the filter control unit 81 are examples of a determining unit and a control unit.

(Operation)

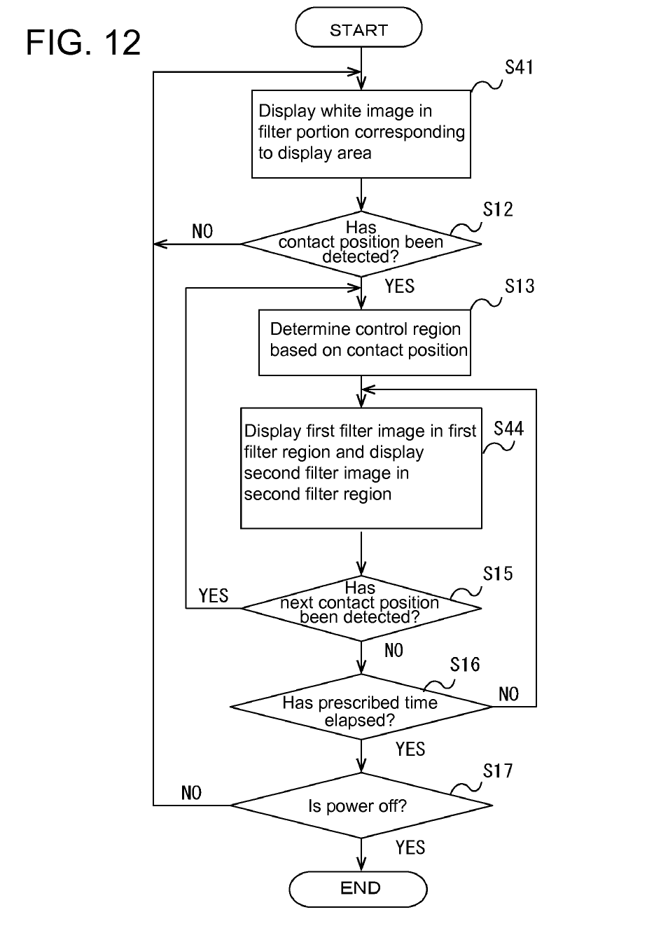

FIG. 12 is a plan view that shows an operational flow of a display device 1A of the present embodiment. An operation example of the display device 1A will be described below with reference to FIG. 12. In this operation example, the power switch of the display device 1 is turned ON in advance.

The control unit 40A outputs to the filter control unit 81 second filter image data to be displayed in the portion of the filter 80 corresponding to the entire display area. The filter control unit 81 outputs to the filter 80 voltage signals based on the second filter image data (step S41). As a result, a white image is displayed in the portion of the filter 80 corresponding to the entire display area. In other words, in this state, light emitted from the backlight 30 is radiated towards the user by passing through the display panel 20, the touch panel 10, and the filter 80, and the brightness of the image of the display device 1A is even.

When the user touches the touch panel 10 through the filter 80, the touch panel control unit 11 transmits to the control unit 40A position information indicating the contact position on the touch panel 10 (step S12=YES). The control unit 40A obtains the position information from the touch panel control unit 11, starts clocking by the clock unit 70, and determines the coordinates of the control region based on the position information (step S13).

Each time a set period of time elapses, the control unit 40A outputs to the filter control unit 81 a signal indicating the coordinates of the first filter region corresponding to the control region and indicating the first filter image data to be displayed in the first filter region, and outputs to the filter control unit 81 a signal indicating the coordinates of the second filter region corresponding to other areas and indicating the second filter region to be displayed in the second filter region. The filter control unit 81 outputs to the filter 80 a voltage signal based on the first filter image data corresponding to the first filter region and outputs to the filter 80 voltage signals based on the second filter image corresponding to the second filter region, based on the signals from the control unit 40A (step S44). As a result, a halftone image is displayed in the first filter region of the filter 80 corresponding to the control region, and a white image is displayed in the second filter region.

The control unit 40A continually performs a process similar to step S44 mentioned above if position information indicating the next contact position is not transmitted by the touch panel control unit 11 (step S15=NO), and if a predetermined time clocked by the clock unit 70 has not elapsed (step S16=NO). Also, the control unit 40 continues a process similar to step S41 described above if a predetermined time clocked by the clock unit 70 has elapsed (step S16=YES), and if an operation to turn OFF the power has not been performed through the operation unit 60 (step S17=NO). As a result, white is displayed in the portion of the filter 80 corresponding to the entire display area.

In Embodiment 4 above, if the user touches the touch panel 10 through the filter 80, a grey image is displayed in the first filter region corresponding to the control region, and in other areas corresponding to the second filter region, a white image is displayed. As a result, the control region is displayed to be darker than other areas, which reduces the brightness of light emitted from the screen at the position where the user performing input is located, thus improving visual characteristics.

### Modification Example

The embodiments of the present invention were described above, but the present invention is not limited to the embodiments above, and modification examples and combinations of modification examples below are also included in the scope of the present invention.

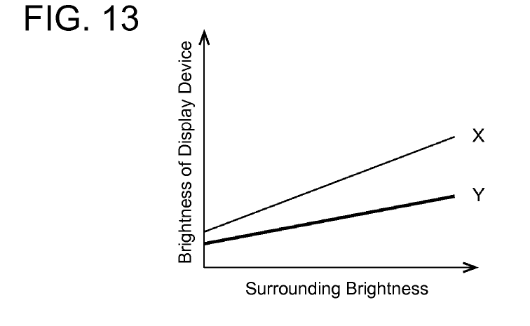

(1) In Embodiments 1 to 4 above, the brightness of the control region and other regions may be controlled based on the results of detecting the brightness of the environment surrounding the display device 1. In the respective embodiments, the relation between the detected brightness of the surrounding environment and the brightness of other areas, and the relation between the detected brightness of the surrounding environment and the brightness of the control region are defined in advance by linear functions indicated by the straight lines X and Y shown in FIG. 13. The control unit determines the brightnesses of the control region and other areas based on the detected brightness of the surrounding environment according to FIG. 13 when the touch panel 10 is touched. The control unit 40 performs control such that at least the control region is at the determined brightness.

In other words, in the case of Embodiment 1, the control unit 40 may control the illumination of the respective light sources 301 corresponding to the control region and other regions in the backlight control unit 31 such that the determined brightness is attained.

In Embodiment 2, the control unit 40 adjusts the respective gradation values of the colors RGB of the image data to be displayed in the control region such that the determined brightness of the control region is attained. In this case, the display device 1 stores a coefficient for adjusting the respective gradation values based on the brightness of the control region in the ROM of the control unit 40 in advance. The control unit 40 may then read in from the ROM the coefficient corresponding to the determined brightness and adjust the gradation values of the respective colors RGB of the image data to be displayed in the control region using this coefficient.

In the case of Embodiment 3, the control unit 40 adjusts the voltage values of the image data to be displayed in the control region in the display panel control unit 21 such that the determined brightness of the control region is attained. In this case, the second voltage value converted by the second voltage conversion unit 202c is set to a voltage value corresponding to the predetermined brightness, for example. The display panel control unit 21 may use a prescribed formula having the brightness of the control region and the second voltage value as parameters to calculate the voltage value corresponding to the determined brightness of the control region to adjust the second voltage value to be the calculated voltage value.

Also, in the case of Embodiment 4, the control unit 40 outputs to the filter control unit 81 image data of a brightness corresponding to the determined brightness of the control region as the first filter image displayed in the first filter region corresponding to the control region. In this case, the display device 1 stores information defining the relation between the brightness of the control region and the brightness of the first filter image in the ROM of the control unit 40 in advance, for example. The control unit 40 may read in information of the brightness corresponding to the determined brightness from the ROM and output the image data of the first filter image to the display panel control unit 21 based on the information of the brightness. In any of these cases, a brightness sensor, for example, may be provided as an example of a light detection unit that detects the brightness of the surrounding environment in the display devices 1 and 1A.

(2) In Embodiments 1 to 4, when the brightness of the control region is controlled, the brightness may be changed gradually. For example, in Embodiment 1, the backlight control unit 31 outputs the voltage signals to the backlight 30 based on the respective predetermined luminance over a predetermined period of time such that the luminance of the control region is gradually shifted from the first luminance to the second luminance. When returning from the second luminance to the first luminance, the voltage signals based on the respective luminances are outputted to the backlight 30 over a predetermined period of time until the luminance is shifted from the second luminance to the first luminance.

In Embodiment 2, when controlling the gradation of the image data to be displayed in the control region such that the gradation is shifted from the first image data to the second image data, over a predetermined period of time, the control unit 40 outputs to the display panel control unit 21 the respective gradation values in which the coefficient by which the gradation values of the first image data are multiplied (the coefficient being less than 1) is changed, for example. The voltage signals based on the respective gradation values may be outputted to the display panel 20 from the display panel control unit 21. When returning from the second image data to the first image data in the control region, the respective gradation values are outputted over the predetermined period of time to the display panel control unit 21 in the order opposite to that described above.

In Embodiment 3, a voltage conversion curve C that determines the relation between the image data and the voltage is set such that the voltage value is between the respective voltage values based on the voltage conversion curves A and B. In the panel control unit 21, the voltage conversion curves A, C, and B are sequentially used over the predetermined period of time, and the image data to be displayed in the control region is converted to the voltage signal and the converted voltage signal is outputted to the display panel 30. Also, when changing the voltage value in the control region from the voltage value based on the voltage conversion curve B to the voltage value based on the voltage conversion curve A, the voltage conversion curves B, C, and A are sequentially used over the predetermined period of time. One or more voltage conversion curves C may be defined.

In Embodiment 4, in the first filter region corresponding to the control region, when shifting from the second filter image (white image) to the first filter image (halftone image), the control unit 40 may output to the filter control unit 81 image data in which the gradation values of the second filter image data are changed gradually over a predetermined period of time in a manner similar to Embodiment 2. When the control region is restored from the first filter image to the second filter image, then image data in which the gradation values of the first filter image are gradually changed over the predetermined period of time in reverse to what was described above is outputted to the filter control unit 81. Besides the method of adjusting the gradation values of the first filter image data and the second filter image data, the voltage values based on the second filter image data and the first filter image data may be gradually changed in a manner similar to Embodiment 3.

(3) Embodiments 1 to 4 described a case in which the number of users performing input on the touch panel 10 is one, but a plurality of users may perform input. In this case, the touch panel 10 is a capacitive touch panel, for example, and simultaneously detects a plurality of contact positions. Display controls similar to those of the embodiments above are performed on the control regions based on the contact positions.

(4) In Embodiments 1 to 4, the color of the control region may be changed gradually. In the case of Embodiment 1, a configuration may be adopted in which the backlight 30 includes RGB LEDs as light sources, and white light is radiated in areas other than the control region and another color besides white is radiated in the control region. For example, by radiating to the control region light of a color darker than in other regions, the image of the control region is displayed to be darker than in other regions.

In the case of Embodiment 2, the control unit 40 may output to the display panel control unit 21 the second image data of a color differing from the first image data such that the gradation values of the image data to be displayed in the control region are reduced. Specifically, in the RGB image data, a coefficient may be multiplied with the gradation values of R and G, with no adjustment made to the gradation value of B, for example, with the image data then being outputted to the display panel control unit 21. As a result, in the control region, an image with a more bluish tone is displayed compared to Embodiment 2.

Also, in the case of Embodiment 3, the display panel control unit 21 may cause the second voltage conversion unit 202c to convert the image data to a second voltage value that is less than the first voltage value such that the color determined for the image data corresponding to the control region differs, with this voltage value subsequently being outputted to the respective source lines 204. Specifically, among the RGB image data, voltage conversion of the R and G image data may be performed by the second voltage conversion unit 202c with voltage conversion being performed on the B image data by the first voltage conversion unit 202b. As a result, in the control region, an image with a more bluish tone is displayed compared to Embodiment 3.

In other words, in the case of Embodiments 2 and 3, similar adjustments are made to the colors RGB of the image data to be displayed in the control region, and thus, the hue of the image prior to adjustment and after adjustment are equal, but the brightness differs. In the present modification example, similar adjustments are not made to the respective colors RGB, and thus, the hue of the image prior to adjustment and after adjustment differ.

(5) In Embodiments 1 to 4, a detection unit that detects the face of the user performing input on the touch panel 10 may be provided in the display devices 1 and 1A. In the present modification example, the detection unit is an imaging device such as a camera, for example. In the present modification example, the control unit 40 does not perform the display control processes described in Embodiments 1 to 4 if the face of the user captured by the imaging device is not facing the direction of the touch panel 10, or in other words, the direction of the display area. That is, when the user is not looking towards the touch panel 10, there is no need to control the brightness of the control region. Therefore, even if the finger of the user is in contact with the touch panel 10, if the face of the user is not facing the direction of the touch panel 10, then the brightness of the control region is not changed. The imaging device is set such that the face of the user is captured when the user performing input faces the direction of the touch panel 10. The control unit 40 analyzes the captured image data and determines that a person within a predetermined range from the imaging device among the subjects captured by the imaging device is the user performing input. When the face of this person is not detected, it is determined that the face of the user performing input is not facing towards the touch panel 10, and if the face of the person is detected, then it is determined that the face of the user performing input is facing towards the touch panel 10. The detection unit and the control unit in the present modification example are examples of a face detection unit.

(6) In Embodiment 2, an example was described in which the color of the image data was expressed in the RGB color space, but the YUV color space may be used. In this case, display of an image in the entire display area according to first YUV values (an example of the first gradation values) indicating the color of the image data to be displayed in the entire display area is set as the first display condition. A second display condition is defined as displaying an image in the control region based on second YUV values (an example of second gradation values) obtained by multiplying the Y value indicating luminance, among the first YUV values indicating the color of the image data to be displayed in the contact region, to a prescribed coefficient less than 1, with other areas displaying an image based on the first YUV values indicating the color of the image data to be displayed in other areas.

(7) In Embodiments 2 and 4, the display panel 20 may be an organic EL (electroluminescent) panel or an LED panel. In Embodiment 3, if the display panel 20 is an organic EL panel or an LED panel, the display panel control unit 21 includes an analog/digital conversion circuit that converts the image data to current signals (first current value, second current value), and the current signals corresponding to the image data are outputted to the display panel 20. In Embodiments 2 to 4, the display panel 20 may be a PDP (plasma display panel).

(8) In Embodiment 1 above, a display control device having the functions of the control unit 40 and the backlight control unit 31 of the display device 1 may be provided separately. In Embodiment 2, a display control device having the function of the control unit 40 may be provided separately. In Embodiment 3, a display control device having the functions of the control unit 40 and the display panel control unit 21 may be provided separately. In Embodiment 4, a display control device having the functions of the control unit 40 and the filter control unit 81 may be provided separately.

(9) The display device of Embodiments 1 to 4 and the modification examples above can be used in digital signage or the like, besides being used as an electronic blackboard.

### INDUSTRIAL APPLICABILITY

The present invention can be applied to the industry of display devices equipped with touch panels.

1. A display control device, comprising:
a designating unit that, when positional information indicating a contact position on a display area of a display panel is inputted, designates as a control region an area of a predetermined range in the display area based on the contact position indicated by the positional information; and
a control unit that performs display control such that in the control region designated by the designating unit, display control is switched from a first display condition preset in the entire display area including the control region to a second display condition in which perceived brightness is reduced compared to the first display condition, and in areas of the display area other than the control region, display control is performed according to the first display condition.

2. The display control device according to claim 1,
wherein the first display condition is a condition in which light is radiated from an illumination unit from a rear of the display panel such that the light is at a first luminance preset for the entire display area, and
wherein the second display condition is a condition in which light is radiated from the illumination unit at a second luminance less than the first luminance in the control region, and at the first luminance in areas other than the control region.

3. The display control device according to claim 1,
wherein the first display condition is a condition in which an image is displayed in the display area on the basis of a first gradation value preset for inputted image data, and
wherein the second display condition is a condition in which an image is displayed in the control region by switching from the first gradation value of the image data inputted to the control region to a second gradation value less than the first gradation value, and an image is displayed in the areas other than the control region on the basis of the first gradation value of image data inputted to said areas other than the control region.

4. The display control device according to claim 1,
wherein the first display condition is a condition in which an image is displayed in the display area on the basis of a first voltage value preset for inputted image data, and
wherein the second display condition is a condition in which an image is displayed in the control region by switching from the first voltage value of the image data inputted to the control region to a second voltage value less than the first voltage value, and an image is displayed in the areas other than the control region on the basis of the first voltage value of image data inputted to said areas other than the control region.

5. The display control device according to claim 1,
wherein the first display condition is a condition in which, in a filter provided to correspond in position with the display panel, a second filter image of a preset color is displayed in a filter region corresponding to the display area, and
wherein the second display condition is a condition in which, in portions of the filter region corresponding to the control region, a first filter image having a lower brightness than the second filter image is displayed, and in portions of the filter region corresponding to the areas other than the control region, the second filter image is displayed.

6. The display control device according to claim 1,
wherein the first display condition is a condition in which an image is displayed in the display area on the basis of a first current value preset for inputted image data, and
wherein the second display condition is a condition in which an image is displayed in the control region by switching from the first current value of the image data inputted to the control region to a second current value less than the first current value, and an image is displayed in the areas other than the control region on the basis of the first current value of image data inputted to said areas other than the control region.

7. The display control device according to claim 1, further comprising:
a light detection unit that detects surrounding light,
wherein the control unit adjusts at least the second display condition on the basis of results of detection performed by the light detection unit.

8. The display control device according to claim 1, further comprising:
a face detection unit that detects a direction that a face of a user performing input faces,
wherein the control unit performs display control according to the second display condition if the face of the user detected by the face detection unit faces the display area.

9. The display control device according to claim 1, wherein the control unit switches from performing display control of the control region according to the second display condition to performing display control according to the first display condition if a predetermined period of time has elapsed from when display control according to the second display condition has started.

10. A display device, comprising:
the display control device according to claim 1;
a display panel that displays an image according to a command from the display control device; and
a touch panel that outputs positional information indicating a position touched by a user to the display control device.
